(19) United States
(12) Patent Application Publication
(10) Pub. No.: US 2012/0280503 A1
(43) Pub. Date: Nov. 8, 2012

(54) EXHAUST ENERGY RECOVERY SYSTEM

(76) Inventor: Imad Mahawili, Napa, CA (US)

(21) Appl. No.: 13/458,279

(22) Filed: Apr. 27, 2012

Related U.S. Application Data
(60) Provisional application No. 61/570,458, filed on Dec. 14, 2011.
(60) Provisional application No. 61/479,897, filed on Apr. 28, 2011.

(51) Int. Cl. H02K 7/18

(52) U.S. Cl. 290/52

(57) ABSTRACT

An energy recovery system includes a fan and a wind turbine adapted to mount adjacent the fan to recover energy from the air flow generated by the fan.

### CROSS-REFERENCE TO RELATED APPLICATION

This application claims the benefit of U.S. provisional Pat. applications Ser. No. 61/570,458, filed Dec. 14, 2011, and Ser. No. 61/479,897, filed Apr. 28, 2011, both entitled EXHAUST ENERGY RECOVERY SYSTEM, which are incorporated by reference herein in their entireties.

### TECHNICAL FIELD AND BACKGROUND OF THE INVENTION

Typical heating, ventilation, and air conditioning systems (HVAC) employ high power fans that move air at high speed across condenser coils to effect a phase change of refrigerant fluid. The liquefied refrigerant subsequently evaporates once it absorbs heat from a given zone within a facility. The HVAC fans move the heat transfer air at high velocity using electric motors. The exhaust air from such HVAC units contains a substantial amount of energy that is simply discharged into the surrounding atmosphere and thus wasted.

### SUMMARY OF THE INVENTION

Accordingly, the present invention provides a system that can recover energy from flowing air, such as airflow to and from an HVAC unit that would otherwise be wasted.

In one form of the invention, a wind turbine is adapted to mount adjacent an intake or exhaust of a ventilation unit, such as an HVAC unit, to thereby recover energy from the intake or exhaust air flow.

In one aspect, the wind turbine comprises a gearless wind turbine.

In another aspect, the wing turbine includes a plurality of wind turbine blades and at least one magnet mounted radially outward or adjacent the tips of the wind turbine blades. In further aspects, a conductive coil is mounted either adjacent or radially outward of the wind turbine blade tips so that when the blades are rotated about their rotational axis, the magnet will induce current flow through the conductive coil.

In yet another aspect, the wind turbine is mounted in a generally horizontal arrangement adjacent the exhaust of the ventilation unit.

According to yet another aspect, the wind turbine is mounted adjacent the exhaust of at least two ventilation units.

In one aspect, the wind turbine is supported above the exhaust of the at least two ventilation units by a manifold, which spaces the wind turbine above the exhaust of the two ventilation units and, further, directs the exhaust of the two ventilation units into the wind turbine.

In a further aspect, the wind turbine includes an annular frame for mounting to the manifold.

According to yet a further aspect, a second wind turbine is mounted to the intake of at least one of the ventilation units. Optionally, a wind turbine may be mounted adjacent the intake of each of the ventilation units.

In this manner, a wind turbine can be used to recover at least some of the energy that is exhausted from a ventilation unit. Consequently, the wind turbine minimizes any back pressure onto the ventilation unit fans, which could otherwise negatively impact the heat transfer rate within the ventilation unit.

These and other objects, advantages, purposes, and features of the invention will become more apparent from the study of the following description taken in conjunction with the drawings.

### BRIEF DESCRIPTION OF THE DRAWINGS

FIG. 1 is a side view and top view of a conventional HVAC unit;

FIG. 2 is a side elevation view of an HVAC unit illustrating the flow of air into and out of the HVAC unit;

FIG. 3 is an exploded perspective view of an exhaust energy recovery system of the present invention;

FIG. 4 is a side view and top view of a prior art multiple exhaust fan HVAC system;

FIG. 5 is a side view of a multiple HVAC unit system incorporating a manifold to direct the air from the exhaust of the several HVAC units;

FIG. 6 is a side view of another embodiment of the exhaust energy recovery system of the present invention incorporating a wind turbine into a multiple exhaust fan HVAC system;

FIG. 7 is a side view of yet another embodiment of the exhaust energy recovery system of the present invention incorporating wind turbines at the air intakes of a multiple exhaust fan HVAC system;

FIG. 8 is a side view of yet another embodiment of the exhaust energy recovery system of the present invention incorporating both wind turbines of the intake and exhaust of a multiple exhaust fan HVAC system;

FIG. 9 is a perspective view of another embodiment of the exhaust energy recovery system of the present invention;

FIG. 10 is a perspective view of the manifold of FIG. 9;

FIG. 11 is a perspective view of another embodiment of the manifold of FIG. 9.

FIG. 12 is a side view of yet another embodiment of an exhaust energy recovery system of the present invention;

FIG. 13 is a side elevation view of a sixth embodiment of an exhaust energy recovery system of the present invention;

FIG. 14 is a seventh embodiment of an exhaust energy recovery system of the present invention;

FIG. 15 is a side elevation view illustrating an example of a suitable support for supporting the wind turbine assembly of FIGS. 12 and 13;

FIG. 15A is a plan view of the base of the support of FIG. 15:

FIG. 16 is an enlarged fragmentary view showing the mounting details of the support to the wind turbine assembly;

FIG. 17 is a top plan view illustrating a suitable blades for any of the wind turbines that may be used in the present invention;

FIG. 18 is an enlarged perspective view of the blade pitch support;

FIG. 19 is a plan view of an exemplary turbine blade in its un-mounted configuration;

FIG. 20 is a perspective view of the wind turbine of the present invention illustrating the wind turbine being supported by multiple supports;

FIG. 21 is an enlarged perspective view illustrating the wind turbine being mounted in close proximity to an evaporator fan cowling; and

FIG. 22 is an enlarged view of the wind turbine in close proximity to the evaporator fan cowling.

### DETAILED DESCRIPTION OF THE PREFERRED EMBODIMENT

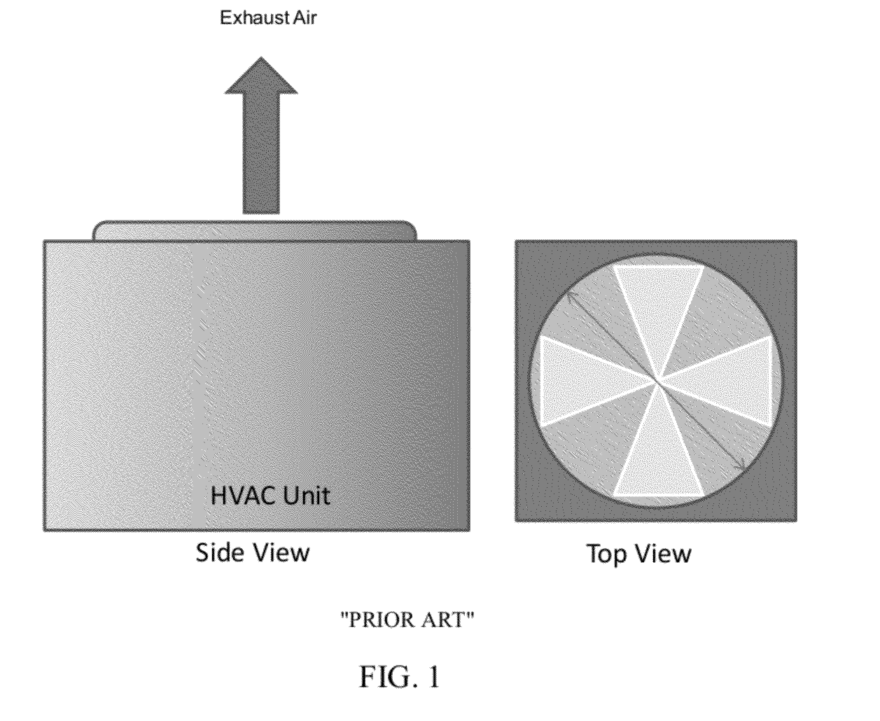

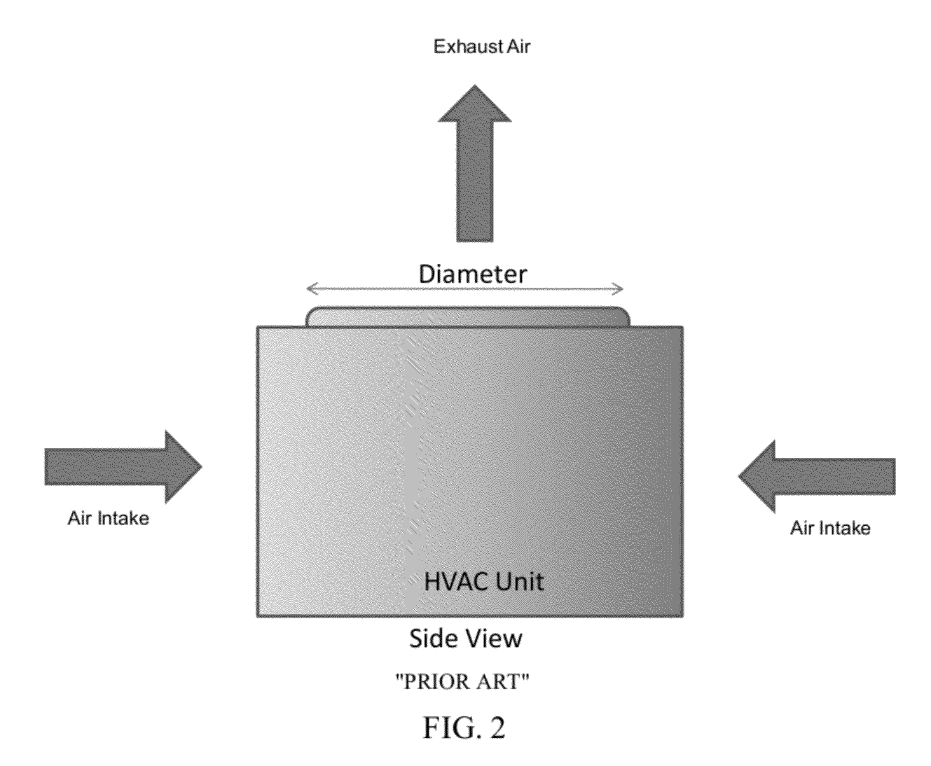

Referring to FIG. 1, FIG. 1 is a schematic of a conventional HVAC unit, with FIG. 2 showing typical air intake and exhaust directions.

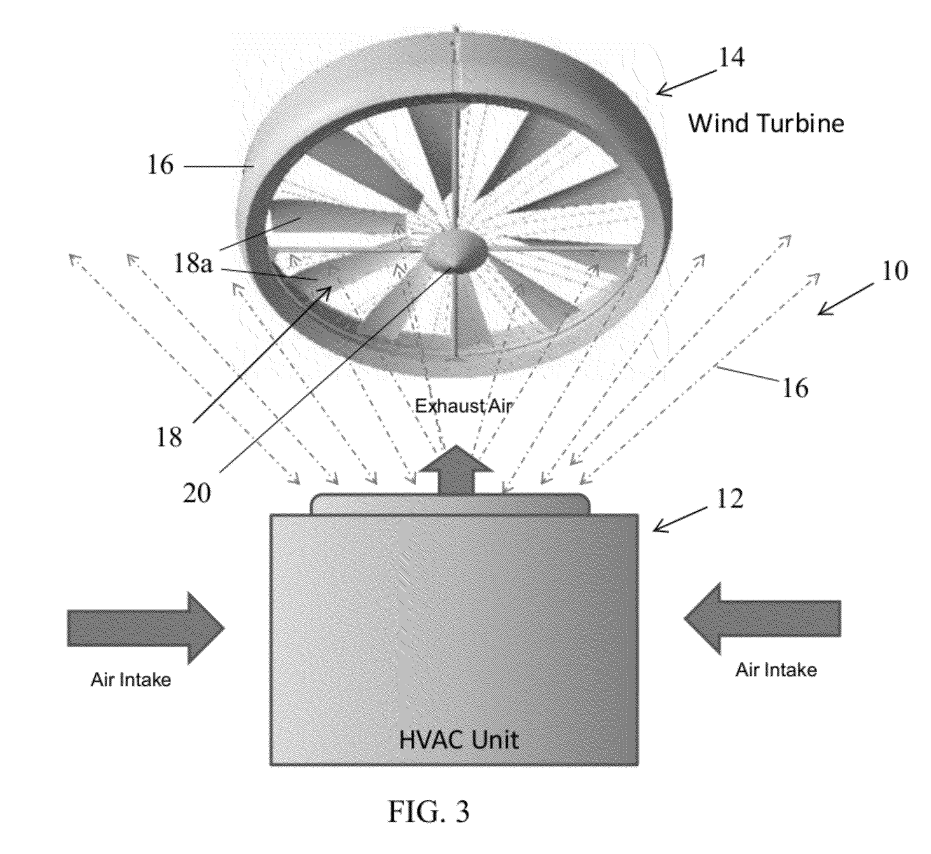

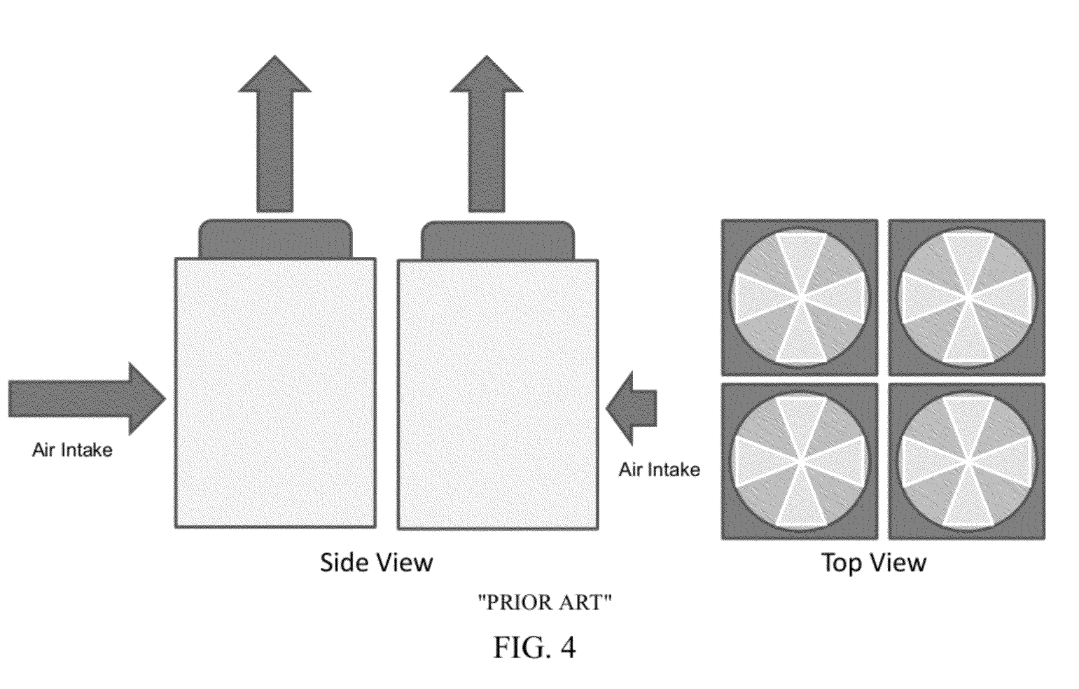

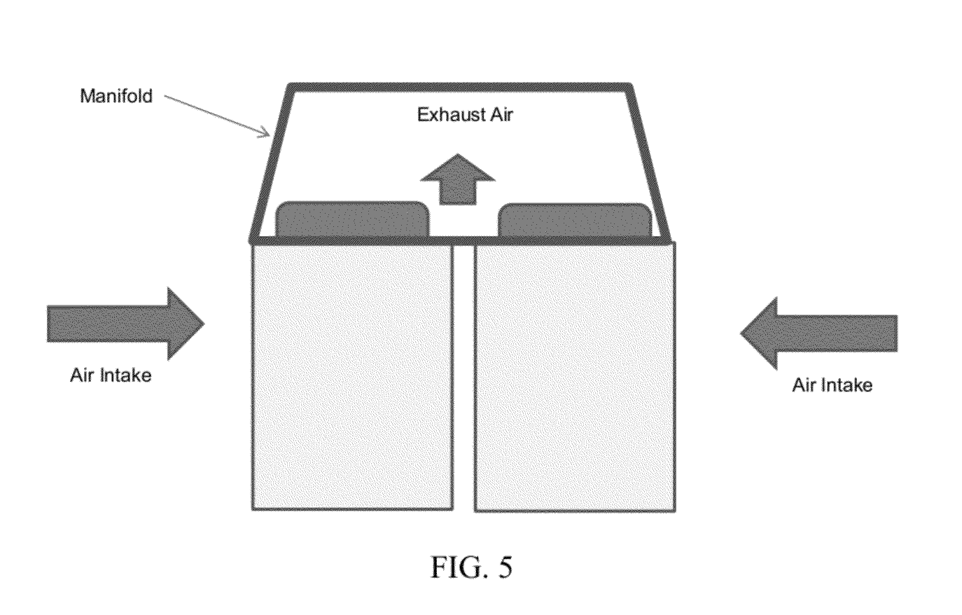

Referring to FIG. 3, the numeral 10 generally designates an exhaust energy recovery system of the present invention, which incorporates a wind turbine for recovering energy from a ventilation unit, such as a conventional HVAC unit shown in FIGS. 1 and 2. Recovery system 10 includes a ventilation unit 12 and a wind turbine 14, which is positioned to recover at least some of the energy in the exhaust air stream 16 from ventilation unit 12. Although hereinafter the system is described in reference to an HVAC unit, it should be understood that the invention is not so limited and that an HVAC unit is used for illustrative purposes only.

As generally shown in FIG. 3, wind turbine 14 includes an annular shroud or member 16 and a wind turbine blade assembly 18, which includes a plurality of turbine blades 18a that are mounted for rotation about a rotational axis 20. For further details of wind turbine 14, reference is made to copending applications U.S. application Ser. No. 12/775,899, filed May 7, 2010, entitled TURBINE ENERGY GENERATING SYSTEM (Attorney Docket No. GRA06 P-100B); U.S. application Ser. No. 12/138,818, filed Jun. 13, 2008, entitled TURBINE ENERGY GENERATING SYSTEM (Attorney Docket No. WIN04 P-101A), now U.S. Pat. No. 8,049,351; U.S. application Ser. No. 12/698,640, filed Feb. 2, 2010, entitled TURBINE ENERGY GENERATING SYSTEM (Attorney Docket No. WIN04 P-102A); U.S. application Ser. No. 12/714,913, filed Mar. 1, 2010, entitled WIND TURBINE (Attorney Docket No. WIN04 P-103A); U.S. application Ser. No. 12/714,982, Mar. 1, 2010, entitled WIND TURBINE AND CONTROL SYSTEM (Attorney Docket No. WIN04 P-104A); U.S. provisional application Ser. No. 61/360,547, filed Jul. 1, 2010, entitled WIND TURBINE WITH EXTENDED BLADES (Attorney Docket No. WIN04 P-105); U.S. provisional application Ser. No. 61/384,949, filed Sep. 21, 2010, entitled WIND TURBINE WITH MULTI-STAGE BLADES (Attorney Docket No. WIN04 P-106), which are incorporated by reference herein in their entireties.

As described in the copending applications, the wind turbine 14 may comprise a gearless turbine and further includes one or more magnets mounted for rotation with the turbine blades, which are spaced either radially outward from the turbine blade tips or adjacent the tips of the turbine blades. Further, the magnet or magnets are aligned with one or more conductive coils that are positioned around the outer perimeter of the turbine blade assembly 18. As described in the co-pending applications, turbine 14 operates at very low air flow and, further, provides little resistance to the air flow as it flows across the respective turbine blades. In this manner, the wind turbine can be used to recover at least some of the energy that is exhausted from an HVAC unit but without causing any significant any back pressure onto the HVAC unit fans, which could otherwise negatively impact the heat transfer rate within the HVAC unit. As will be more fully described below, the wind turbine may also be located in the intake side of the HVAC unit and, further, may be positioned to recover the energy of several HVAC units by way of a manifold.

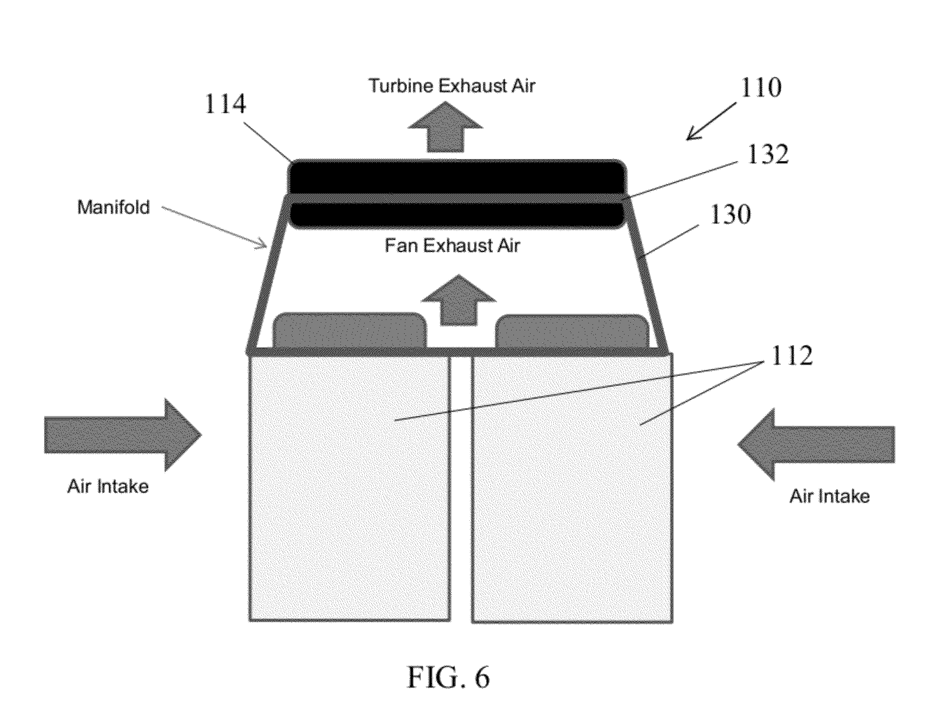

Referring to FIG. 6, the numeral 110 generally designates another embodiment of the exhaust energy recovery system of the present invention. System 110 includes a plurality of HVAC units 112 and, further, includes a manifold 130, which directs the exhaust from the respective HVAC units through an upper plenum 132 of the manifold 130. Manifold 130 may be fabricated out of sheet metal, steel, aluminum, or even a variety of plastic materials or a combination thereof. System 110 also includes at least one wind turbine 114, similar to wind turbine 14 as described in reference to system 10, which is sized to span at least a portion of the exhaust of both HVAC units and, further, is adapted to be mounted in the plenum 132 so that the air flow from the manifold is directed into the wind turbine to thereby allow the wind turbine to recover at least some of the energy exhausted by HVAC units 112. As noted previously, for further details of a suitable wind turbine 14, reference is made to the above noted copending applications.

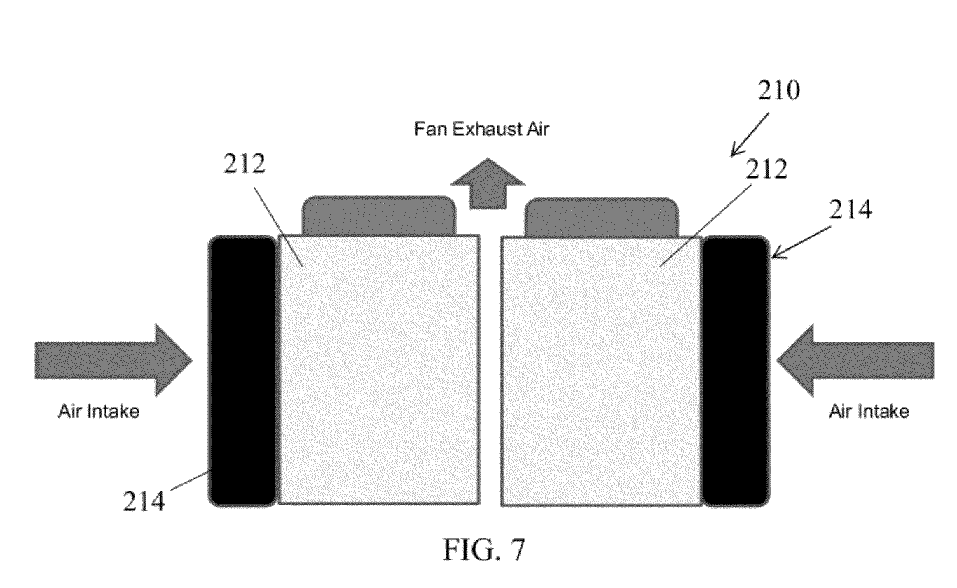

Referring to FIG. 7, the numeral 210 generally designates another embodiment of the exhaust energy recovery system of the present invention in which the HVAC units 212 may each include a wind turbine 214 mounted adjacent their intake so that the wind turbines recover energy from the air flow into the respective HVAC systems. Wind turbine 214 may be mounted by supports or brackets to the respective HVAC unit housing. Again, for further details of the wing turbine, reference is made to the above noted copending applications.

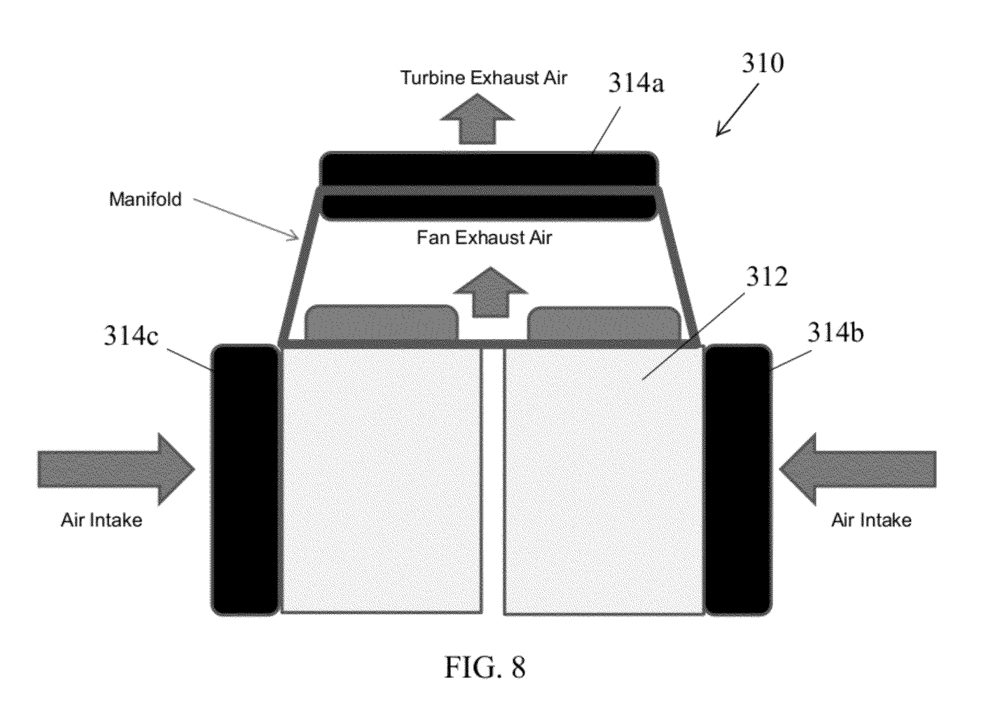

Referring to FIG. 8, the numeral 310 generally designates another embodiment of the exhaust energy recovery system of the present invention which, similar to system 210, mounts a turbine 314a adjacent the exhaust of two or more HVAC units 312 and, further, incorporates wind turbines 314b, which are positioned and mounted adjacent the intake of the respective HVAC units.

As would be understood from the above description, the wind turbine or wind turbines can be used to recover some of the energy in HVAC's the exhaust air stream. Further, the wind turbine is configured so that it does not induce a substantial back pressure onto the fans to slow the air velocity, which might negatively impact the heat transfer rate within the HVAC unit. The turbine can be used to recover such waste energy from this exhaust air when placed above such HVAC exhaust system as shown in FIG. 3 or from the intake air flow. It has been experimentally shown that when a wind turbine of the type described herein is used in this application the back pressure increase was a fraction of a millimeter of mercury, less than 0.1 mm Hg up to fan flow rates up to 80,000 cubic feet per minute. When compared to filters that are typically used in such HVAC unit, which can create up to 5 mm Hg back pressure, this back pressure created by the wind turbine of the present invention is relatively insignificant. On the other hand, the energy recovered by the wind turbine in the form of electricity can be up to 15 to 20 percent of the input motor energy and can be fed back to the grid or charge batteries depending on the specific application.

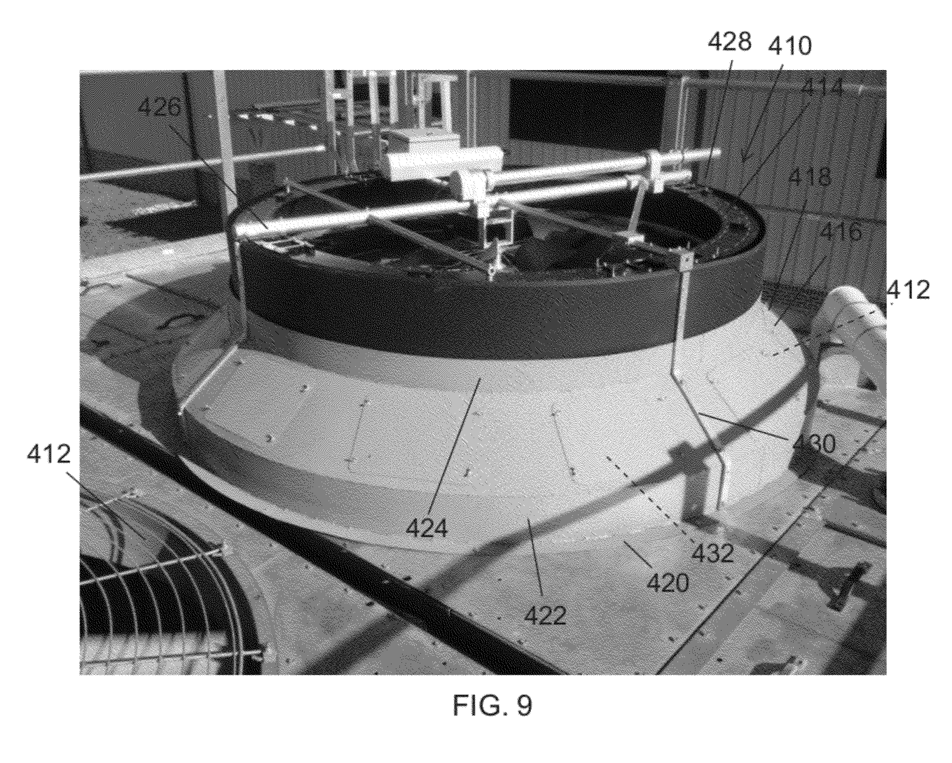

Referring to FIG. 9, the numeral 410 generally designates another embodiment of the exhaust energy recovery system of the present invention. System 410 similarly includes a wind turbine 414, which is mounted adjacent the exhaust of a fan 412, for example, of an evaporative cooling tower. For details of wind turbine 414, reference is made to the above incorporated pending applications and patent.

In the illustrated embodiment, wind turbine 414 is mounted over fan 412 by a manifold 416, which directs the flow of air from the fan into the wind turbine to drive the wind turbine, thereby generating electricity. In the illustrated embodiment, the diameter of the fan 412 is larger than the diameter of the wind turbine, thus manifold 416 is adapted to direct the air flow from fan 412 inwardly toward wind turbine 414.

Manifold 416 may be formed from sheet metal, such as steel or aluminum sheet metal, and in the illustrated embodiment has a circular configuration with a base flange 420 that mounts to the evaporative cooling tower housing around fan 412, an annular wall 422, which extends around the perimeter of the fan 412, and an inwardly angled transition portion 418, which is angled in a range of 30° to 60° and, further, which includes a support flange 424 on which wind turbine 414 is supported and, further, mounted.

As best seen in FIG. 9, wind turbine 414 includes a mounting frame 426, which extends transversely across the stator housing 428 of wind turbine 414 and which provides a mounting surface for the wind turbine wheel as described in the referenced application. Frame 426 is used to mount wind turbine 414 to manifold 416 by way of frame members or mounting brackets 430, which are optionally secured to housing 428 of wind turbine 414 and, further, anchored to manifold 416, for example by fasteners, welds, or the like.

In this manner, all the air flow from the fan of the cooling tower is directed in to the wind turbine, which induces rotation of the wind turbine wheel to thereby generate electricity as understood from the description in the referenced applications and patents. By angling the transition portion 418 of the manifold between about 30° to 60°, the back pressure generated by wind turbine 414 will be lowered, which will decrease the potential loss of efficiency in the fan due to back pressure from turbine 414. One objective of the system is to recover energy from the exhaust air without adversely affecting the evaporator's heat exchange performance.

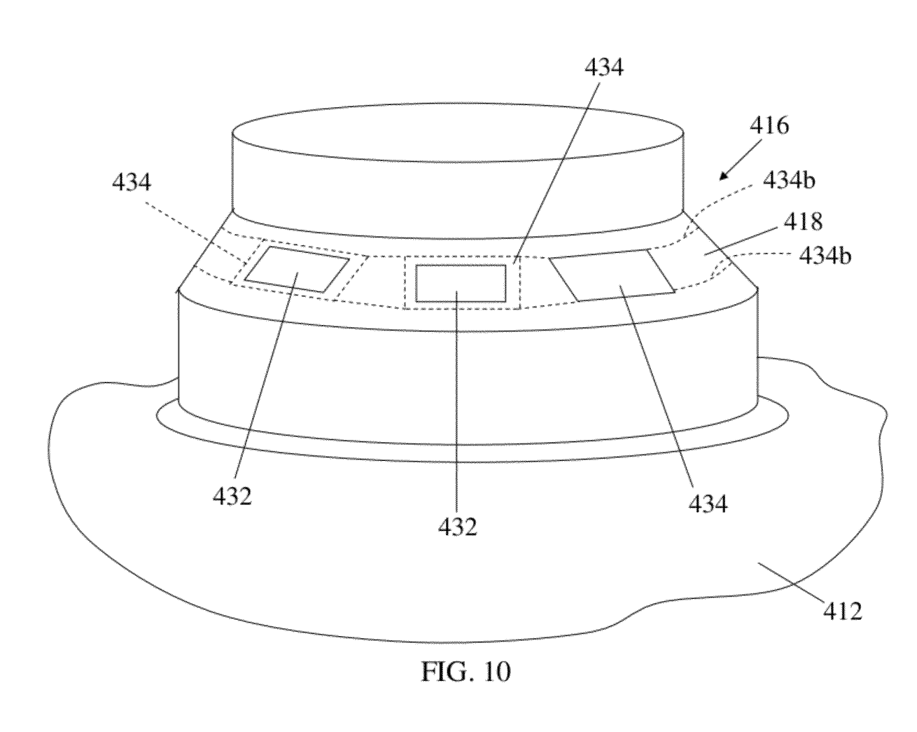

Further to that end, manifold 416 is adapted to vary the air flow through the manifold. In the illustrated embodiment and as best seen in FIG. 10, manifold 416 optionally includes one or more vent openings 432, for example, in transition portion 418, which may be partially or fully closed by panels 434, which overlay the respective openings. Openings 432 may all have the same size or may be varied (and even further may be graduated in size form a first size, to a second increased size, and to a third increased size for example). In addition, openings 432 may be evenly spaced around the perimeter of manifold 414 or unevenly spaced. Alternately or in addition, the openings may be provided in annular wall 422.

Panels 434 may be similarly formed from sheet metal or the like and may be fixedly mounted to manifold 416 over the openings and then during installation or during a pre-installation process may be removed to uncover one or more openings to suit the specific installation. Fans vary greatly in their speed, size and output. Therefore, in order to match the pressures of the fan and of the turbine, openings 432 may be uncovered to reduce the back pressure generated by the turbine in response to the air flowing though the turbine from the fan.

Optionally, panels 434 may be releasably or movably (e.g. slidably) mounted to manifold 416, for example by fasteners or rails or tracks 434a, 434b so that they may be removed or adjusted after or during installation to adjust the airflow (e.g. uncover or partially uncover the opening or openings 432 to adjust any back pressure generated by the wind turbine) to suit the particular installation and improve efficiency. In this manner, the manifold may be configured so that the back pressure on the respective fan generated by turbine 414 can be adjusted.

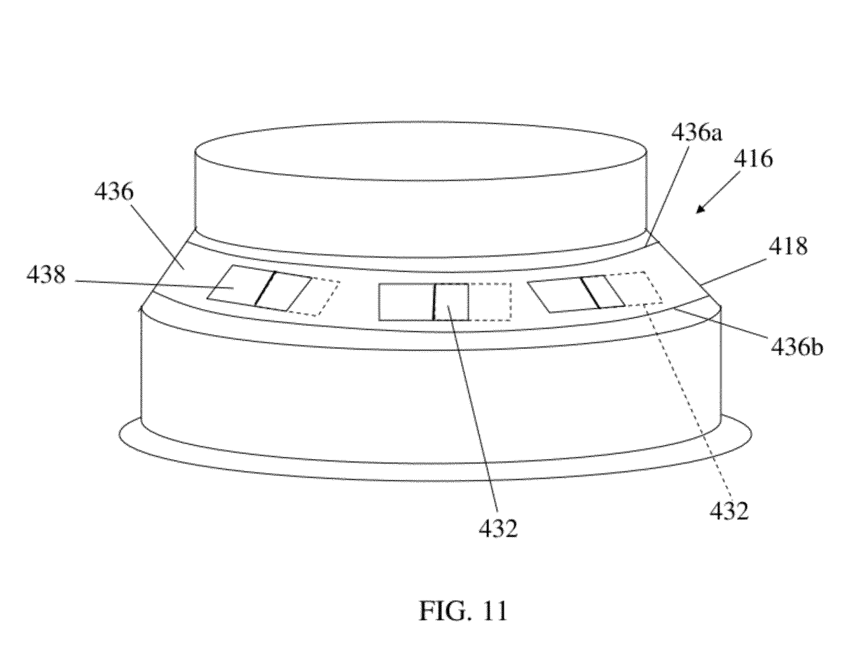

Referring to FIG. 11, transition portion 418 may alternatively include an annular member 436 (or a member than spans two or more openings 432) supported, for example on a pair of rails or tracks 436a and 436b, with a corresponding plurality of openings 438, which are sized and arranged so that when aligned with openings 432 optionally fully uncover the openings to allow air flow through the openings to reduce the back pressure on the fan. Further, annular member 436 may be positioned so that openings 438 only partially aligned with openings 432 to partially uncover openings 432. Alternately or in addition, openings 438 may be smaller in one or both dimensions so that even when fully aligned, openings 432 will only be partially uncovered. Thus, when annular member 436 is rotated each of respective openings 432 of manifold 414 may be uncovered simultaneously and further to the same degree to keep a balanced adjustment to the air flow.

Further, with a single panel (annular member), the panel may be automated and moved in response to control signals, for example, generated by a control system that may be provided to monitor the back pressure and/or load on the fan (or fans in multiple fan applications) to maintain efficient operation of the fan or fans. In this manner, the control of the opening (full or partial) may be automated and tied to controlling the efficiency of the fan(s) and wind turbine.

For example, in one installation, for a single fan having a diameter of 7.5 feet, with a total flow of 78,000 cubic feet per minute (cfm) it has been found that the turbine power output can range from 765 watts to 1,000 watts for a 100% duty cycle, resulting in an annual energy recovery in a range of about 6,700 kWh to 8,760 kWh.

As noted above, optionally, panel 434 may be fixed in place by removable fasteners or by non-removable fasteners (such a welds or rivets) and, further, may be supported for sliding motion between a pair of rails (not shown) so that the respective panels may be slid into place over the respective openings 432 to thereby allow the opening 432 to be partially uncovered or partially closed. It should be understood that the number and size of openings may be increased or decreased as desired. Further, while the openings are illustrated evenly spaced around the perimeter of the manifold, it should be understood that a single opening may be provided and, further, the openings do not need to be equally spaced or even balanced around the manifold. However, with a balanced configuration of openings, balancing the back pressure may be more easily achieved.

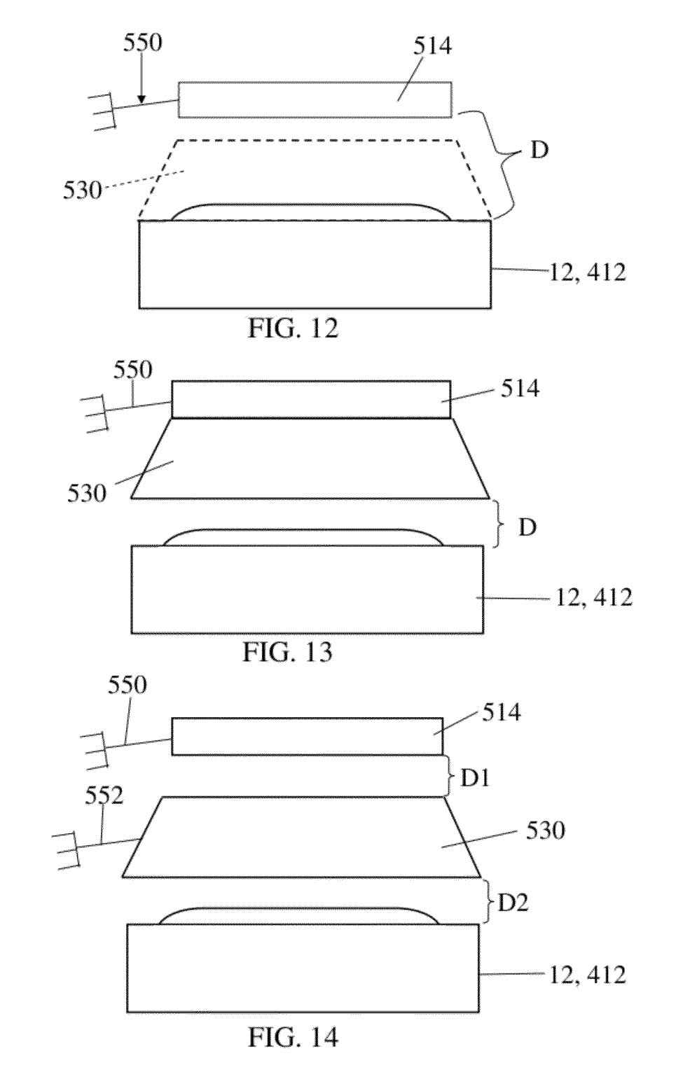

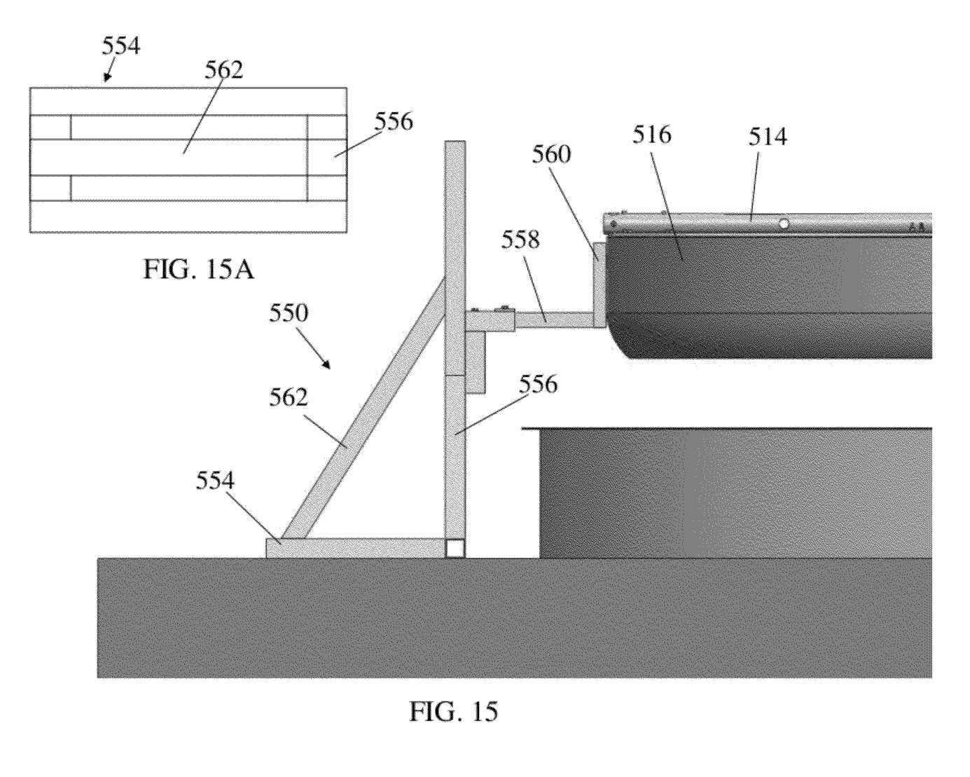

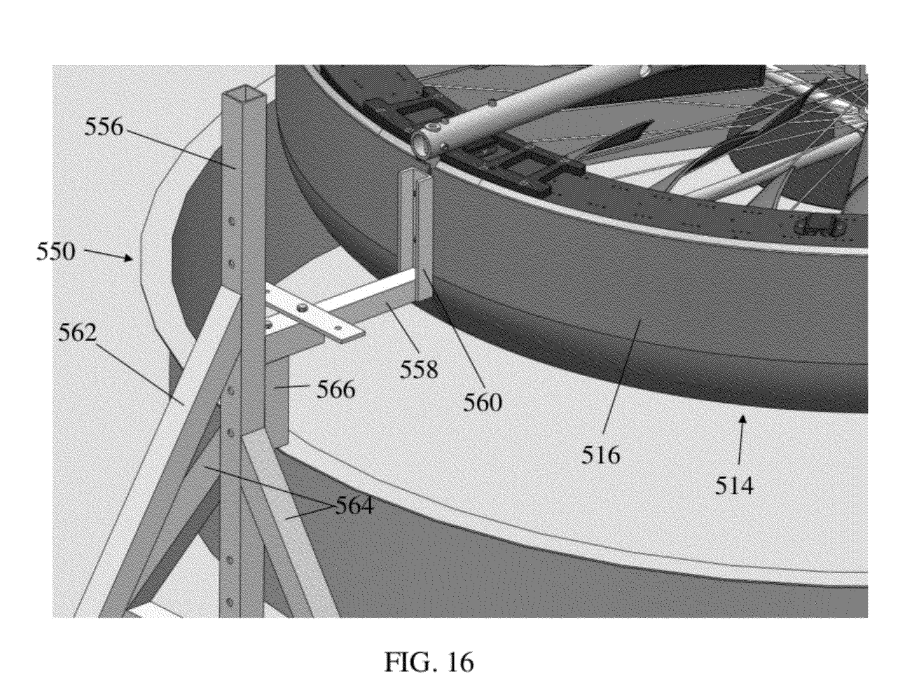

Referring to FIG. 12, the numeral 510 generally designates another embodiment of an exhaust energy recovery system of the present invention. In the illustrated embodiment, exhaust energy recovery system 510 includes a wind turbine 514 (which may be of similar construction to the previously described wind turbines), which is configured for placement over a ventilation unit 12 or a fan 412 to recover at least some of the energy of the air flow from the HVAC unit or fan in a similar manner described above. However, in the present embodiment, wind turbine 514 is supported by a support 550 at a distance D above the HVAC unit 12 or fan 412 to further reduce the potential for back pressure on the HVAC unit or fan. For details of support 550, reference is made to FIGS. 15, 15A, and 16, which are described below. By spacing the fan above the HVAC unit or fan, the configuration effectively provides a 360° vent, which has been found to reduce the back pressure to essentially zero.

Alternately, a manifold 530, which may take the form of the manifolds described previously, may be interposed between the wind turbine 514 and the HVAC unit and fan and mounted to the fan or HAV unit, with the distance then measured between the top of the manifold and the bottom of the wind turbine.

Alternately, referring to FIG. 13, the manifold 530 may be mounted about the wind turbine 514, which is supported together along with the wind turbine by support 550 but with the bottom of the manifold spaced above HVAC unit 12 or fan 412 the same distance D. Again the result is a 360° vent, which has been found to reduce the back pressure to essentially zero.

Referring to FIG. 14, system 510 may be reconfigured such that the wind turbine 514 is supported by support 550 a distance D1 above manifold 530, which in turn is supported by a support 552 above HVAC unit 12 or fan 412 and spaced at a distance D2 above the HVAC unit or fan. Therefore, two three hundred and sixty degree vents are provided, one between the HVAC unit/fan and the manifold, and another between the manifold and the HVAC unit/fan.

Suitable spacings for D, D1, and D2 include a distance in a range of about 1″ to 12″, in a range of about 3″ to 10″, or a range from about 4″ to 8″.

Referring to FIG. 15, support 550 includes a base 554 for example a box-shaped base, such as shown in FIG. 15A, which may be formed by interconnected structural members, such as conventional metal tubular members, and a vertical stand 556, which extends upwardly from the base. Stand 556 may also be formed a structural member, such as conventional metal tubular member, and supports a cantilevered arm 558, which secures to the side of wind turbine 515 by way of a bracket 560 mounted to shroud 516. Optionally, stand 556 includes a bracing member 562 that extends between stand 556 and base 554.

Referring to FIG. 16, stand 556 may include additional lateral bracing 564 that extends between stand 556 and base 554. Similarly, cantilevered arm 558 may be reinforced by a vertical bracing member 556 mounted to stand 556, which stiffens the stand 556 at the mounting point of cantilevered arm 558 to stand 556. As best seen in FIG. 16, a suitable bracket 560 may comprise a channel-shaped member, which is riveted, welded, fastened or otherwise secured to the shroud 516 of wind turbine 514.

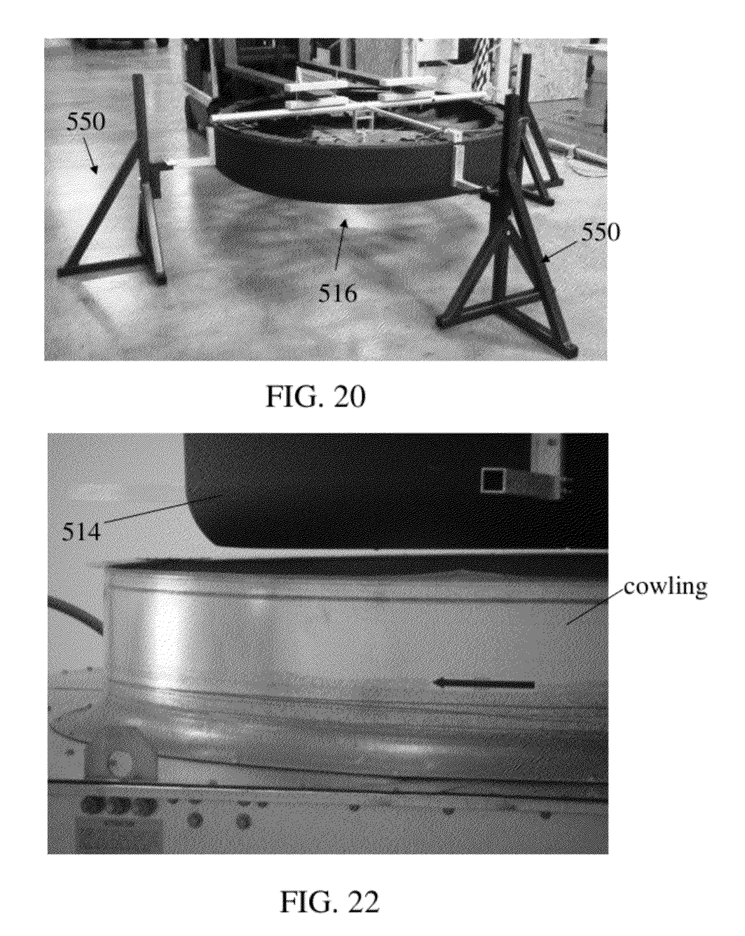

As would be understood by those skilled in the art, the various members forming the support 550 may be joined together by fasteners to allow the support to be disassembled or adjusted or may be assembled using welds or rivets or other conventional permanent or semi-permanent fastening mechanisms. Further, the materials forming support 550 may include metal, as note, or wood or a composite material, such as a reinforced polymer. Further, rather than providing cantilevered support, two or more supports may be used, such as show in FIG. 20, in which case the supports may be simplified and need not be so robust.

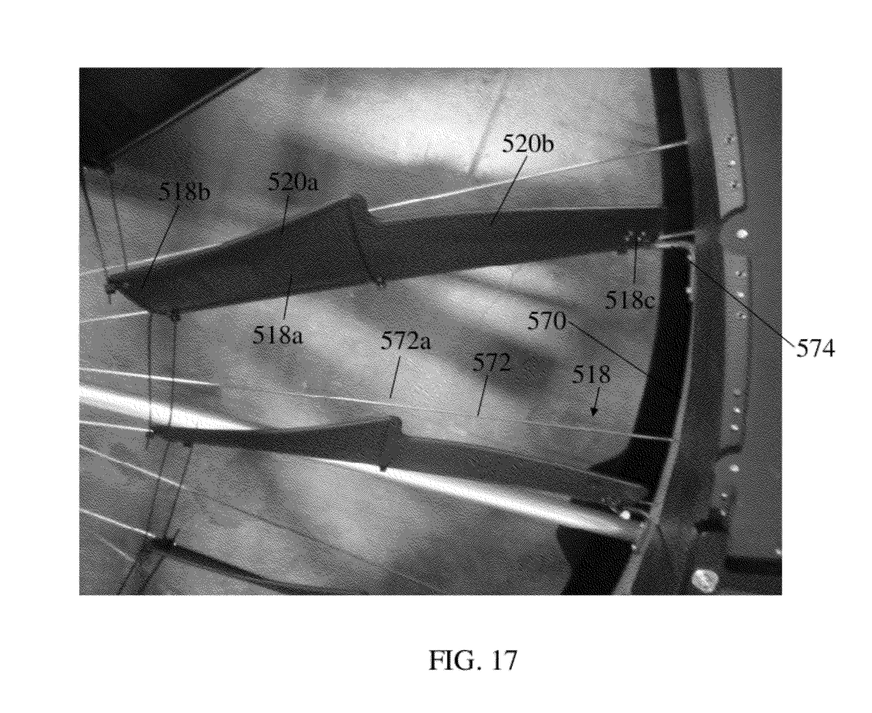

Referring again to FIG. 17, blades 518a of wind turbine 518 may optionally be reoriented from the positions described in the above-referenced applications such that the proximal ends 518b of each blade 518a is rotated to a generally orthogonal orientation to the plane of rotation of wind turbine blade assembly 518, but then twisted such that a portion of the upper edge of the blade 520a curves inwardly so that a portion of the blade extends in a direction that forms an acute angle with respect to the plane of rotation of wind turbine blade assembly 518. The distal end of the blade is therefore also twisted relative to the proximal end so that the distal end of the blade is twisted in a direction that forms an acute angle with respect to the plane of rotation of wind turbine blade assembly 518. For example, as noted below, the distal end of each blade may form an angle in a range of about 10 degrees to 60 degrees, in a range of about 20 degrees to 40 degrees, and in range of 28 to 32 degrees with respect to the plane of rotation of wind turbine blade assembly 518.

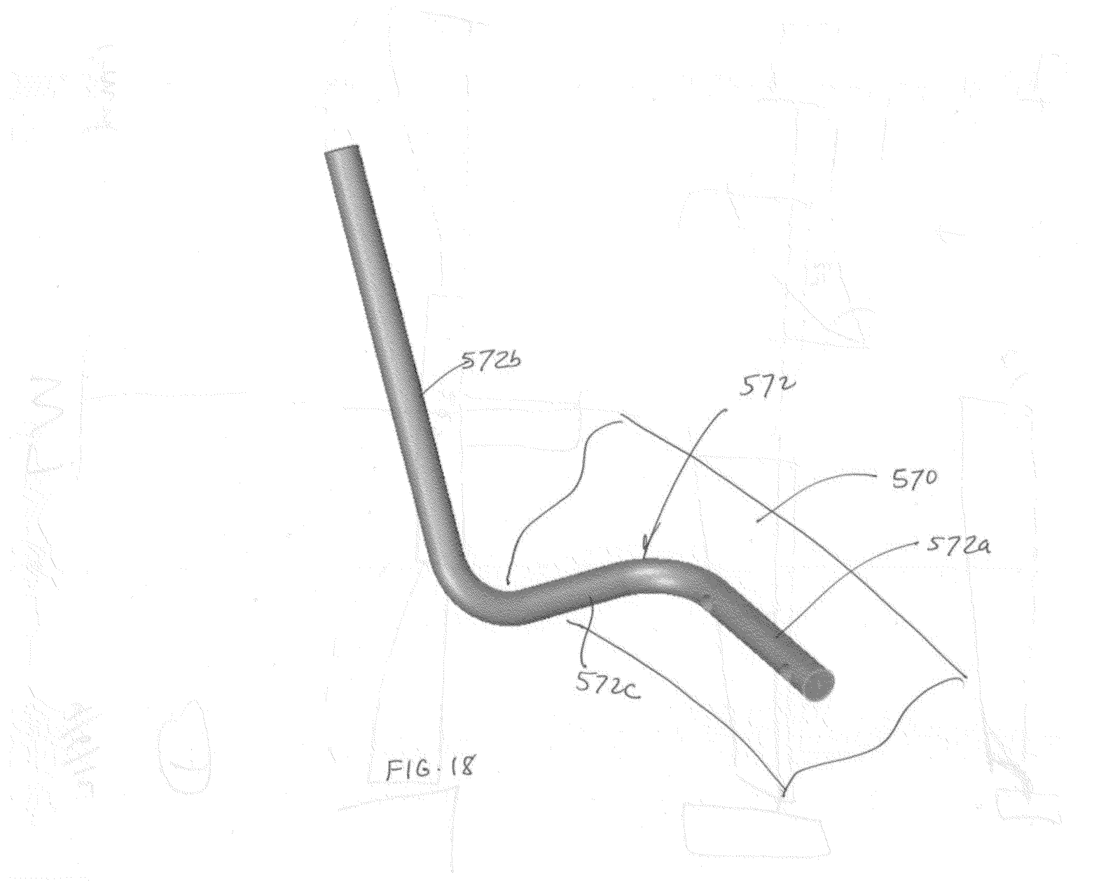

To maintain the blade in its desired orientation, blade assembly 518 may optionally incorporate blade supports 574. Referring to FIG. 18, each blade support 572 includes a first mounting portion 572a, which secures to the rim 570 of the wind turbine assembly 518, and a second mounting portion 572b, which secures to the distal end of the blade to orient the blade as noted above at a pitch in range from about 10° to 60°, from about 20° to 40°, from about 28° to 32°, and optionally at about 30°. Further, mounting portion 572a and 572b are interconnected by an intermediate portion 572c, which locates the blade distal end inwardly from rim 570. Blade pitch support 572 may have a generally Z-like configuration with intermediate portion 572c forming an offset portion. For example, blade supports 574 may be formed from a Z-shaped bar or rod.

Furthermore, as noted the distal ends of blades 518a may be spaced inwardly from the rim 570 of the wind turbine blade assembly, and the proximal ends of blades 518a may be spaced outwardly from the central axis of the wheel assembly 572 so that they align with or mirror the blades of the fan below. In this manner, the blades 518 do not extend over the dead space of the fan below.

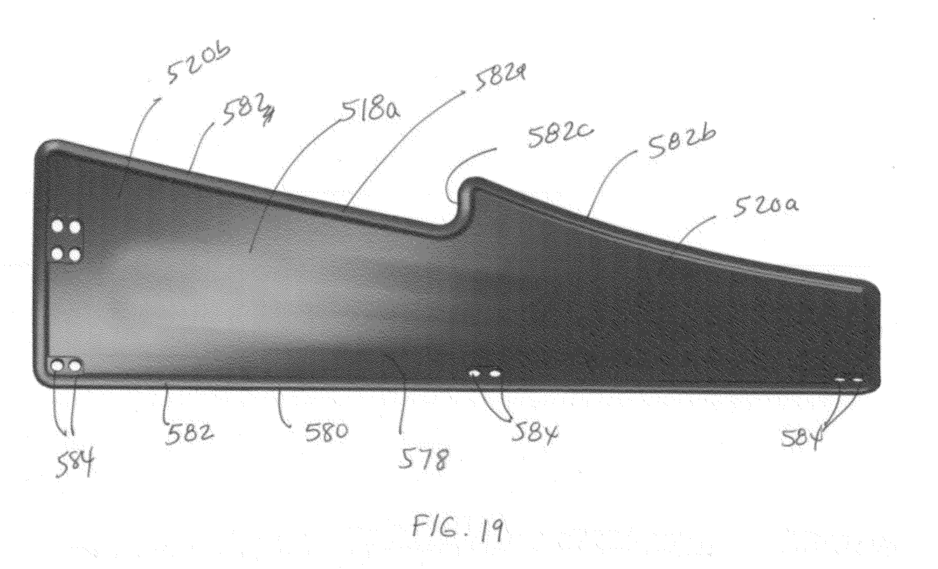

Referring to FIG. 19, blade 518a is shown in its un-twisted configuration and includes web 578 with a first longitudinal edge 580, which is generally straight. Edge 580 is reinforced by an enlarged rib 582, which extends around the full perimeter of the web (blade). A second edge 582, as noted above, forms a stepped profile for the outer edge of the blade. As best seen in FIG. 19, edge 582 includes a first portion 582a and a second portion 582b, which is angled with respect to first portion 582a and may optionally be generally parallel to edge 582a but offset by stepped portion 582c, which results in upper portion 520a of blade 518 having a greater surface area and also allows it to be twisted to a greater degree than lower portion 520b of blade 518a.

The connections to the respective spokes 572a of wheel 572 may be achieved by way of openings 584 formed in web 578 of each blade 518a. As described in the referenced applications, the blades may be mounted using clips and, further, with clips that provide elasticity and/or elongation to allow the blade to move relative to the wheel assemblies 572 when certain wind levels are encountered. Further, while illustrated with a stepped profile, each blade 518a may have a non-step profile such that the blade edge extends directly between the blade tip and the blade distal end with an uninterrupted continuous slope.

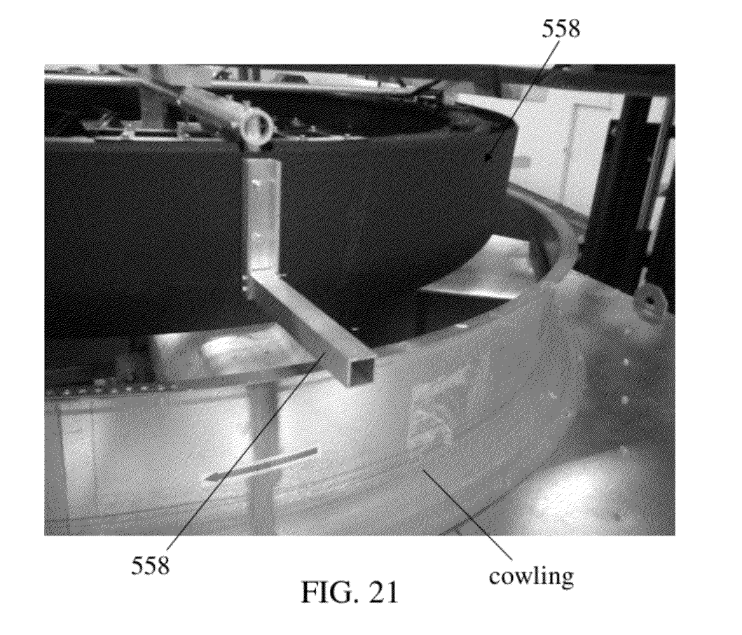

Alternately, referring to FIGS. 21 and 22, a turbine with standard blades (described in the cited applications) or the modified blades, for example, shown in FIGS. 16, 17, and 19, can be lowered to a very close range to the evaporator fan. Tests have shown excellent results when the turbine is placed within a couple of inches of the fan with hardly any detectable back pressure change, and therefore no measureable change in the evaporator performance. Evaporators and HVAC fans are usually protected by a guard, and in this application the turbine may become the guard. For example, a wire mesh, such as an approximately 2 inch by 4 inch mesh grid, may be used to cover the downward face of the turbine. This guard can be extended to cover not only the turbine face and its shroud but also the annular area beyond its diameter and to the evaporator fan sheet metal cowling. Thus, the turbine of the present invention may also be used as an effective safety “net” for such evaporator fans. In this embodiment, arms 558 may be directed supported on the upwardly extending cowling of the fan, or as described before may be mounted to a stand 556 of a support 550 as described above.

Optionally, in any of the above embodiments, the wind turbine may incorporate a deflector over the hub to reduce, if not eliminate, fluid energy loss through the center part of the wind turbine. For example, a suitable deflector may comprise a disc or conical plate (see FIG. 3 for example), which may be formed from metal or a plastic, mounted to the frame of the turbine and centered over the hub of the turbine blade assembly. A suitable metal includes aluminum or steel. For example, for a 7.5 foot or larger fan, the deflector may comprise a 20 inch diameter disc formed from about ⅛ inch thick aluminum plate.

It should be understood, although described in the context of an HVAC and evaporation cooling tower, the wind turbine can be used to recover energy from the exhaust of other fans, including from the very high scale air flows used in automobile paint facilities and in coal and other mines, to name a few examples. Further, as described, when HVAC units contain more than one exhaust fan then a manifold can be used to combine the flow of multiple fans into one wind turbine. This manifold integrates the flow these fans into one turbine such that the turbine can extract energy from the waste exhaust air stream even when some of the fans are turned off due to the specific HVAC controller function that optimize the total duty cycle of the HVAC unit. Alternately, each fan of a multiple fan assembly may include a wind turbine associated therewith to enhance the ability to match the pressure of the fan with the wind turbine so that the fan will operate more efficiently. Also as described, the wind turbine can be placed on the input to the HVAC in single or multiple units or on top of the manifold.

While several forms of the invention have been shown and described, other forms will now be apparent to those skilled in the art. It should be understood that the embodiments shown in the drawings and described above are merely for illustrative purposes, and are not intended to limit the scope of the invention which is defined by the claims which follow as interpreted under the principles of patent law including the doctrine of equivalents.

What is claimed is:

1. An energy recovery system comprising:
a fan; and
a wind turbine is adapted to mount adjacent the fan to recover energy from the air flow generated by the fan.

2. The energy recovery system according to claim 1, wherein the fan comprises an exhaust fan.

3. The energy recovery system according to claim 1, wherein the fan has an inlet and an exhaust, the wind turbine being mounted in a generally horizontal arrangement adjacent the exhaust of the fan.

4. The energy recovery system according to claim 1, wherein the fan has an inlet and an exhaust, the wind turbine being mounted in a generally vertical arrangement adjacent the inlet of the fan.

5. The energy recovery system according to claim 1, wherein the wind turbine includes a plurality of blades and at least one magnet mounted adjacent or outboard of the distal ends of the blades and rotatable with the blades but in a manner so that the weight of the magnet is not borne by the blades.

6. The energy recovery system according to claim 5, further comprising a conductive coil mounted either adjacent or radially outward of the magnet so that air flow from the fan will flow across the blades and induce the blades to rotate and thereby induce current flow through the conductive coil.

7. The energy recovery system according to claim 1, wherein the wind turbine comprises a gearless wind turbine.

8. The energy recovery system according to claim 1, wherein the wind turbine has a wind turbine blade tip diameter less than the outer diameter of the fan blades.

9. The energy recovery system according to claim 1, wherein the wind turbine is mounted spaced from the fan by a manifold.

10. The energy recovery system according to claim 9, wherein the manifold is tapered and includes a transition portion that directs the air flow from the fan into the wind turbine.

11. The energy recovery system according to claim 9, wherein the manifold is adapted to reduce back pressure generated by the wind turbine.

12. The energy recovery system according to claim 1, wherein the wind turbine is mounted spaced from the fan to form a 360 degree vent.

13. The energy recovery system according to claim 12, wherein a tapered manifold is interposed between the wind turbine and the fan.

14. The energy recovery system according to claim 13, wherein the manifold is mounted to the wind turbine, and the 360 degree vent is formed between the manifold and the fan.

15. The energy recovery system according to claim 13, wherein the manifold is mounted to the fan, and the 360 degree vent is formed between the wind turbine and the manifold.

16. The energy recovery system according to claim 13, wherein the manifold is spaced from the wind turbine and the fan.

17. The energy recovery system according to claim 1, wherein the wind turbine blades have a length approximately equal to the fan blade length of the fan.

18. A method of energy recovery comprising:
positioning a wind turbine adjacent a fan;
venting the air flow between the fan and the wind turbine to balance the pressures between the wind turbine and the fan.

19. The method according to claim 18, wherein said venting includes spacing the wind turbine from the fan.

20. The method according to claim 18, further comprising directing the air flow from the fan into the turbine.
